(19) United States
(12) Patent Application Publication
(10) Pub. No.: US 2012/0212640 A1
(43) Pub. Date: Aug. 23, 2012

(54) ELECTRONIC DEVICE

(75) Inventor: Kazuhiro KOJIMA, Osaka City (JP)

(73) Assignee: SANYO ELECTRIC CO., LTD., Moriguchi City (JP)

(21) Appl. No.: 13/403,442

(22) Filed: Feb. 23, 2012

(30) Foreign Application Priority Data
Feb. 23, 2011 (JP) 2011-037235

(51) Int. Cl. H04N 5/225

(52) U.S. Cl. 348/222.1; 348/E05.024

(57) ABSTRACT

An electronic device has an input image acquisition section which acquires a plurality of input images obtained by shooting a subject group from mutually different viewpoints and an output image generation section which generates an output image based on the plurality of input images. The output image generation section eliminates the image of an unnecessary subject within an input image among the plurality of input images by use of another input image among the plurality of input images, and generates, as the output image, an image from which the unnecessary subject has been eliminated.

This nonprovisional application claims priority under 35 U.S.C. §119(a) on Patent Application No. 2011-037235 filed in Japan on Feb. 23, 2011, the entire contents of which are hereby incorporated by reference.

### BACKGROUND OF THE INVENTION

1. Field of the Invention

The present invention relates to electronic devices such as image-shooting devices.

2. Description of Related Art

When a main subject is shot by use of an image-shooting device, an unnecessary subject (unnecessary object) may be shot together. In particular, for example, when, as shown in FIG. 13, an unnecessary subject 913 is located between an image-shooting device 901 and main subjects 911 and 912, although the user wants to shoot an image as shown in FIG. 14A, part or the whole of the main subjects 911 and 912 is shielded by the unnecessary subject 913, with the result that the actually shot image appears as shown in FIG. 14B. In FIG. 14B, the dotted region (the region filled with dots) represents the back of the head of the subject 913 that is a person (the same is true of FIG. 14C, which will be mentioned below).

By translating or rotating the image-shooting device 901, it is possible to shoot the whole of the main subjects 911 and 912 as shown in FIG. 14C, indeed; in that case, however, the composition of the shot image may deviate from that the photographer desires (that is, the composition may turn out to be poor).

Various methods have been proposed of eliminating an unnecessary subject (unnecessary object) appearing in a shot image through image processing. For example, methods have been proposed of eliminating speckles and wrinkles on the face of a person in a shot image by application of noise reduction processing or the like.

Inconveniently, however, image processing methods like those mentioned above cannot correctly interpolate the part of the image that is shielded by the unnecessary subject 913 (in FIG. 14B, part of the bodies of the main subjects 911 and 912), and this makes it difficult to obtain a satisfactory processed image.

### SUMMARY OF THE INVENTION

An electronic device is provided with: an input image acquisition section which acquires a plurality of input images obtained by shooting a subject group from mutually different viewpoints; and an output image generation section which generates an output image based on the plurality if input images. Here, the output image generation section eliminates the image of an unnecessary subject within an input image among the plurality of input images by use of another input image among the plurality of input images, and generates, as the output image, an image from which the unnecessary subject has been eliminated.

### BRIEF DESCRIPTION OF THE DRAWINGS

FIG. 1 is a schematic overall block diagram of an image-shooting device embodying the invention;

FIG. 2 is an internal configuration diagram of the image-sensing section in FIG. 1;

FIG. 3A is a diagram illustrating the significance of subject distance; FIG. 3B is a diagram showing an image of interest; FIG. 3C is a diagram illustrating the significance of depth of field;

FIG. 4 is a diagram showing a positional relationship between the image-shooting device and a plurality of subjects, as assumed in an embodiment of the invention;

FIGS. 5A, 5B, and 5C are diagrams showing a plurality of shot images as can be acquired by the image-shooting device shown in FIG. 1;

FIG. 6 is a block diagram of part of the image-shooting device shown in FIG. 1;

FIG. 7 is a diagram showing a plurality of input images in an embodiment of the invention;

FIGS. 8A, 8B, and 8C are diagrams showing specific examples of a plurality of input images in an embodiment of the invention;

FIG. 9 is a diagram illustrating the significance of distance range in an embodiment of the invention;

FIG. 10 is a diagram showing an example of an output image in an embodiment of the invention;

FIG. 11 is an operation flow chart of an image-shooting device embodying the invention;

FIG. 12A is a diagram showing a preview image in an embodiment of the invention; FIGS. 12B and 12C are diagrams showing display images based on the preview image;

FIG. 13 is a diagram showing a positional relationship between an image-shooting device and a plurality of subjects according to prior art; and

FIGS. 14A, 14B, and 14C are diagrams showing a plurality of shot images as can be acquired by a conventional image-shooting device.

### DETAILED DESCRIPTION OF PREFERRED EMBODIMENTS

Hereinafter, examples of how the present invention is embodied will be discussed specifically with reference to the accompanying drawings. Among the different drawings referred to in the course, the same parts are identified by the same reference signs, and in principle no overlapping description of the same parts will be repeated. Throughout the present specification, for the sake of simple notation, particular data, physical quantities, states, members, etc. are often referred to by their respective reference signs alone, with their full designations omitted, or in combination with abbreviated designations. For example, while an input image is identified by the reference sign I[i] (see FIG. 7), this input image I[i] may also be referred to as the image I[i] or, simply, I[i].

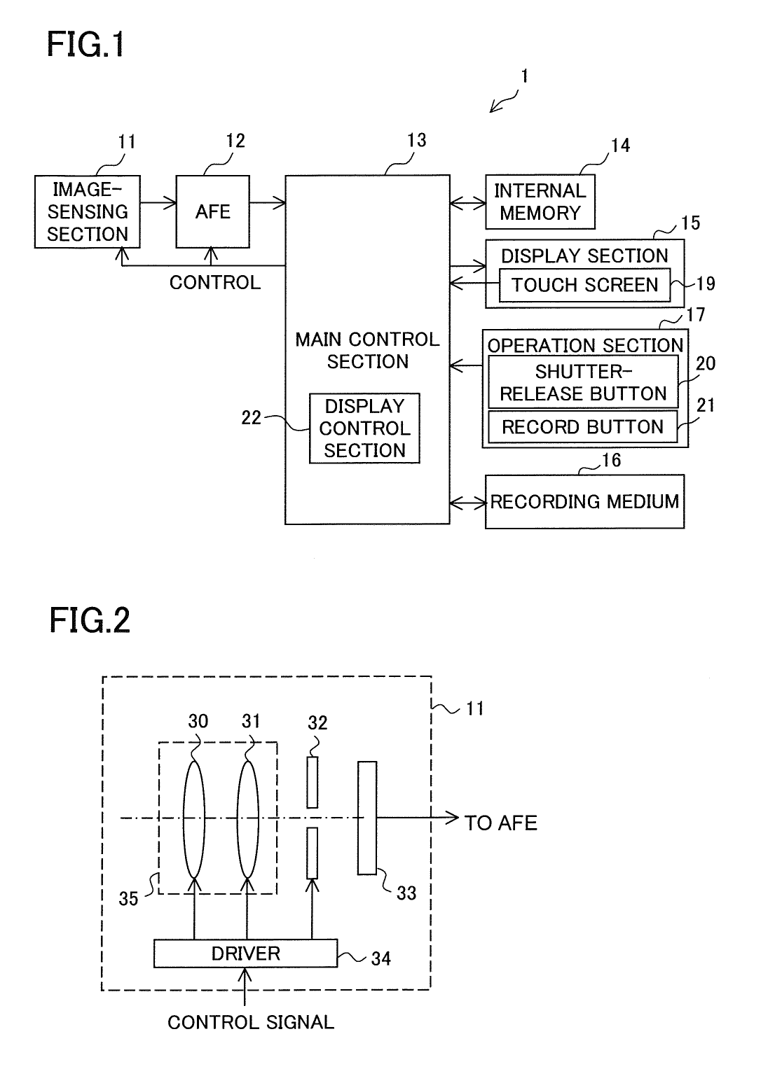

FIG. 1 is a schematic overall block diagram of an image-shooting device 1 embodying the invention. The image-shooting device 1 is a digital video camera that can shoot and record still and moving images. The image-shooting device 1 may be a digital still camera that can shoot and record only still images. The image-shooting device 1 may be one that is incorporated in a portable terminal such as a cellular phone.

The image-shooting device 1 is provided with an image-sensing section 11, an AFE (analog front end) 12, a main control section 13, an internal memory 14, a display section 15, a recording medium 16, and an operation section 17. The display section 15 may be though of as being provided in an external device (not shown) separate from the image-shooting device 1.

The image-sensing section 11 shoots a subject by use of an image sensor. FIG. 2 is an internal configuration diagram of the image-sensing section 11. The image-sensing section 11 includes an optical system 35, an aperture stop 32, an image sensor (solid-state image sensor) 33 that is a CCD (charge-coupled device) or CMOS (complementary metal oxide semiconductor) image sensor or the like, and a driver 34 for driving and controlling the optical system 35 and the aperture stop 32. The optical system 35 is composed of a plurality of lenses including a zoom lens 30 for adjusting the angle of view of the image-sensing section 11 and a focus lens 31 for focusing. The zoom lens 30 and the focus lens 31 are movable along the optical axis, which here denotes the optical axis in the image-sensing section 11 (the optical axis in the image-shooting device 1). According to control signals from the main control section 13, the positions of the zoom lens 30 and the focus lens 31 within the optical system 35 and the aperture size (that is, aperture value) of the aperture stop 32 are controlled.

The image sensor 33 has a plurality of photoreceptive pixels arrayed both horizontally and vertically. The photoreceptive pixels of the image sensor 33 perform photoelectric conversion on the optical image of the subject incoming through the optical system 35 and the aperture stop 32, and output the resulting electric signals to the AFE (analog front end) 12.

The AFE 12 amplifies the analog signal output from the image-sensing section 11 (image sensor 33), converts the amplified analog signal into a digital signal, and then outputs the digital signal to the main control section 13. The amplification factor of the signal amplification by the AFE 12 is controlled by the main control section 13. The main control section 13 applies necessary image processing to the image represented by the output signal of the AFE 12, and generates a video signal representing the image having undergone the image processing. An image represented by the output signal as it is of the AFE 12, or an image obtained by applying predetermined image processing to an image represented by the output signal as it is of the AFE 12, is referred to as a shot image. The main control section 13 is provided with a display control section 22 for controlling what the display section 15 displays, and controls the display section 15 in a way necessary to achieve display.

The internal memory 14 is an SDRAM (synchronous dynamic random-access memory) or the like, and temporarily stores various kinds of data generated within the image-shooting device 1.

The display section 15 is a display device having a display screen such as a liquid crystal display panel and, under the control of the main control section 13, displays a shot image, an image recorded on the recording medium 16, or the like. In the present specification, what are referred to simply as “display” or “display screen” are those on or of the display section 15. The display section 15 is provided with a touch screen 19; thus, by touching the display screen of the display section 15 with an operating member (a finger or a touch pen), the user can feed the image-shooting device 1 with particular commands. The touch screen 19 may be omitted.

The recording medium 16 is a non-volatile memory such as a card-type semiconductor memory or a magnetic disk and, under the control of the main control section 13, records the video signal of shot images and the like. The operation section 17 includes, among others, a shutter-release button 20 for accepting a command to shoot a still image and a record button 21 for accepting commands to start and end the shooting of a moving image, and accepts various operations from outside. How the operation section 17 is operated is conveyed to the main control section 13. The operation section 17 and the touch screen 19 may be referred to as a user interface for accepting arbitrary commands and operations from the user; accordingly, in the following description, the operation section 17 or the touch screen 19 or both are referred to as the user interface. The shutter-release button 20 and the record button 21 may be buttons on the touch screen 19.

The image-shooting device 1 operates in different modes, including a shooting mode in which it can shoot and record images (still or moving images) and a playback mode in which it can play back, on the display section 15, images (still or moving images) recorded on the recording medium 16. The different modes are switched according to how the operation section 17 is operated.

In shooting mode, a subject is shot periodically, at predetermined frame periods, so that shot images of the subject are acquired sequentially. A video signal representing an image is also referred to as image data. A video signal contains, for example, a luminance signal and a color difference signal. Image data corresponding to a given pixel may also be referred to as a pixel signal. The size of an image, or of an image region, is also referred to as an image size. The image size of an image of interest, or of an image region of interest, can be expressed in terms of the number of pixels constituting the image of interest, or belonging to the image region of interest. In the present specification, the image data of a given image is occasionally referred to simply as an image. Accordingly, generating, acquiring, recording, processing, modifying, editing, or storing an input image means doing so with the image data of that input image.

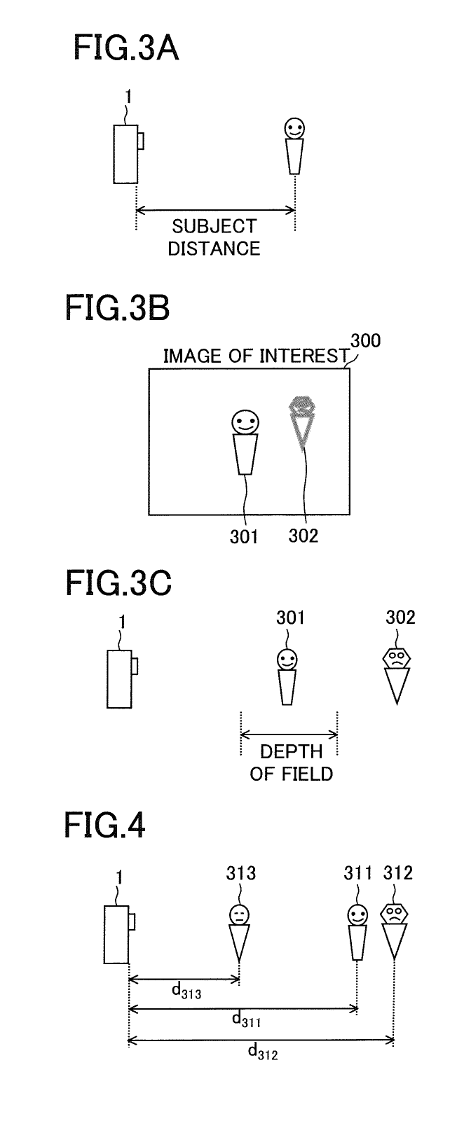

As shown in FIG. 3A, the distance in real space between a given subject and the image-shooting device 1 (more specifically, the image sensor 33) is referred to as a subject distance. During the shooting of an image of interest 300 shown in FIG. 3B, a subject 301, of which the subject distance falls within the depth of field of the image-sensing section 11, is in focus on the image of interest 300, whereas a subject 302, of which the subject distance falls out of the depth of field of the image-sensing section 11, is out of focus on the image of interest 300 (see FIG. 3C). In FIG. 3B, different degrees of blur in the subject images are expressed by different breadths of the contour lines of the subjects.

All the subjects that fall within the shooting region of the image-shooting device 1 are collectively refereed to as the subject group. The subject group includes one or more main subjects that are of interest to the photographer as well as one or more unnecessary subjects that are objects unnecessary to the photographer. Subjects may be referred to as objects (accordingly, for example, the subject group, main subjects, and unnecessary subjects may also be referred to as the object group, main objects, and unnecessary objects respectively). In the embodiment under discussion, as shown in FIG. 4, it is assumed that the subject group includes subjects 311 to 313 that are persons, and that the photographer recognizes the subjects 311 and 312 as main subjects and the subject 313 an unnecessary subject. The subject distances of the subjects 311, 312, and 313 are represented by the reference signs d₃₁₁, d₃₁₂, and d₃₁₃ respectively. Here, the inequality 0<d₃₁₃<d₃₁₁<d₃₁₂ holds. That is, the unnecessary subject 313 is located between the image-shooting device 1 and the subjects 311 and 312. It is also assumed that the image-shooting device 1 and the subjects 311 to 313 are located substantially on a straight line. The subject group may further include any background subject (for example, a hill or a building) other than the subjects 311 to 313. A background subject denotes a subject whose subject distance is greater that those of main subjects. Accordingly, the subject distance of a background subject is greater than the distances d₃₁₂.

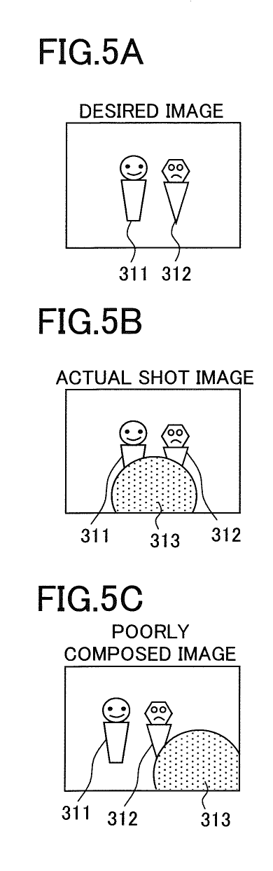

The photographer, that is, the user, wants to shoot an image as shown in FIG. 5A that does not show the subject 313. The presence of the subject 313, however, compels the actual shot image to appear, for example, as shown in FIG. 5B. In FIG. 5B, the dotted region (the region filled with dots) represents the back of the head of the subject 313 (the same is true of FIGS. 5C, 8A-8C, etc., which will be mentioned later). On the shot image in FIG. 5B, part of the main subjects 311 and 312 is shielded by the back of the head of the subject 313. By translating or rotating the image-shooting device 1, it is possible to shoot the whole of the main subjects 311 and 312 as shown in FIG. 5C, indeed; in that case, however, the composition of the shot image may deviate from that the photographer desires.

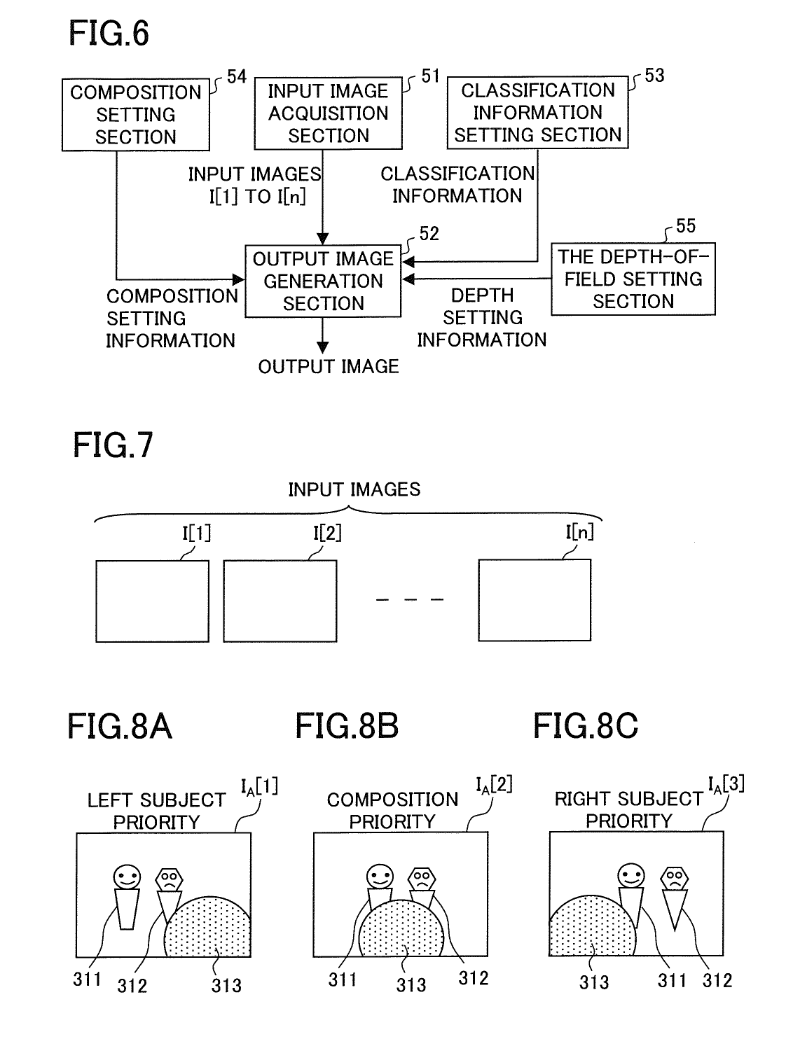

Even in a situation as shown in FIG. 4, the image-shooting device 1 can generate an image (hereinafter referred to as the output image) in a proper composition with respect to main subjects. FIG. 6 is a block diagram of the sections particularly involved in the generation of the output image. The sections identified by the reference signs 51 to 55 in FIG. 6 can be provided, for example, in the main control section 13 in FIG. 1.

An input image acquisition section 51 acquires a plurality of input images based on the output signal of the image-sensing section 11. By shooting the subject group periodically or intermittently, the image-sensing section 11 can acquire shot images of the subject group sequentially. The input images are each a still image (that is, a shot image of the subject group) obtained by shooting the subject group by use of the image-sensing section 11. The input image acquisition section 51 can acquire the input images by receiving the output signal of the AFE 12 directly from it. Instead, shot images of the subject group may first be stored on the recording medium 16 so that they will then be read out from the recording medium 16 and fed to the input image acquisition section 51; this too permits the input image acquisition section 51 to acquire input images.

As shown in FIG. 7, the plurality of input images are identified by the reference signs I[1] to I[n] (where n is an integer of 2 or more). Parallax occurs between input image I[i] and input image I[j] (where i and j are integers fulfilling i≠j). In other words, input images I[i] and I[j] are shot from different view points. That is, the position of the image-shooting device 1 (more specifically, the position of the image sensor 33) at the time of the shooting of input image I[i] differs from the position of the image-shooting device 1 (more specifically, the position of the image sensor 33) at the time of the shooting of input image I[j]. FIGS. 8A to 8C show, as an example of input images I[1] to I[n], input images I_{A}[1] to I_{A}[3]. In the example shown in FIGS. 8A to 8C, n=3. Input image I_{A}[1] is an image shot with priority given to the left-hand main subject, namely the subject 311; input image I_{A}[2] is an image shot with priority given to a good composition; input image I_{A}[3] is an image shot with priority given to the right-hand main subject, namely the subject 312. In the embodiment under discussion, for the sake of simple explanation, it is assumed that, during the shooting of input images I[1] to I[n], the subjects 311 to 313 remain stationary in real space and the subject distances d₃₁₁ to d₃₁₃ remain unchanged.

For example, input images I[1] to I[n] can be generated by one of the three methods of input image generation described below.

A first method of input image generation is as follows. In the first method of input image generation, a plurality of shot images obtained while the image-shooting device 1 is, for example, panned are acquired as a plurality of input images. More specifically, in the first method of input image generation, while keeping the subject group within the shooting region of the image-shooting device 1, the user holds down the shutter-release button 20 and gradually changes the position of the image-shooting device 1 (and the shooting direction) (for example, pans the image-shooting device 1). Throughout the period for which the shutter-release button 20 is held down, the image-sensing section 11 repeats the shooting of the subject group periodically, so as thereby to obtain a plurality of shot images (shot images of the subject group) in a chronological sequence. The input image acquisition section 51 acquires those shot images as input images I[1] to I[n].

A second method of input image generation is as follows. In the second method of input image generation, as in the first method of input image generation, a plurality of shot images obtained while the image-shooting device 1 is, for example, panned are acquired as a plurality of input images. The difference is that, in the second method of input image generation, when to shoot each input image is expressly specified by the user. Specifically, in the second method of input image generation, for example, while keeping the subject group within the shooting region of the image-shooting device 1, the user gradually changes the position of the image-shooting device 1 (and the shooting direction) and presses the shutter-release button 20 each time a notable change is made. In a case where the shutter-release button 20 is pressed sequentially at a first, a second, . . . and an n-th time point, the shot images taken by the image-shooting device 1 at those time points are obtained as input images I[1], I[2], . . . and I[n] respectively.

A third method of input image generation is as follows. In the third method of input image generation, input images are extracted from a moving image. Specifically, for example, the subject group is shot in the form of a moving image MI by use of the image-sensing section 11, and the moving image MI is first recorded to the recording medium 16. As is well known, a moving image MI is a sequence of frame images obtained through periodic shooting at predetermined frame periods, each frame image being a still image shot by the image-sensing section 11. In the third method of input image generation, out of a plurality of frame images of which the moving image MI is composed, n frame images are extracted as input images I[1] to I[n]. Which frame images of the moving image MI to extract may be specified by the user via the user interface. Instead, the input image acquisition section 51 may, based on an optical flow or the like among frame images, identify frame images suitable as input images so that n frame images identified as such will be extracted as input images I[1] to I[n]. Instead, all the frame images of which the moving image MI is composed may be used as input images I[1] to I[n].

A distance map generation section (not shown) can generate a distance map with respect to each input image by performing subject distance detection processing on it. The distance map generation section can be provided in the main control section 13 (for example, in an output image generation section 52 in FIG. 6). In the subject distance detection processing, the subject distance of a subject at each pixel of the input image is detected and, from distance data representing the results of the detection (the detected value of the subject distance of the subject at each pixel of the input image), a distance map is generated. A distance map is a range image (distance image) of which each pixel has as its pixel value the detected value of the subject distance. The distance map identifies the subject distance of the subject at each pixel of the input image. Distance data and distance maps are both a kind of subject distance information. The subject distance can be detected by any method including those well-known. The subject distance may be detected by a stereo method (the principle on which trigonometry is based) from a plurality of input images having parallax among them, or may be detected by use of a distance measurement sensor.

A output image generation section 52 in FIG. 6 generates an output image based on input images I[1] to I[n] such that the unnecessary subject 313 does not appear in the output image (in other words, such that the image data of the unnecessary subject 313 is not included in the output image. The generated output image can be displayed on the display section 15, and can also be recorded to the recording medium 16. In the following description, what is referred to simply as “recording” is recording to the recording medium 16. When recorded, image data may be compressed.

The image processing performed by the output image generation section 52 to generate the output image from input images I[1] to I[n] is referred to as the output image generation processing. When generating the output image, the output image generation section 52 can use a distance map and parallax information as necessary. Parallax information denotes information representing the parallax between arbitrary ones of input images I[1] to I[n]. The parallax information identifies, with respect to the position of the image-shooting device 1 and the direction of the optical axis at the time of the shooting of input image I[i], the position of the image-shooting device 1 and the direction of the optical axis at the time of the shooting of input image I[j]. The parallax information may be generated from the result of detection by a sensor (not shown) that detects the angular velocity or acceleration of the image-shooting device 1, or may be generated by analyzing an optical flow derived from the output signal of the image-sensing section 11.

Generating the output image as described above requires information with which to make the output image generation section 52 recognize which subject is unnecessary, and this information is referred to as classification information. According to the classification information, the output image generation section 52 can classify each subject included in the subject group as either a main subject or an unnecessary subject, or classify each subject included in the subject group as a main subject, an unnecessary subject, or a background subject. In a given two-dimensional image, an image region where the image data of a main subject is present is referred to as a main subject region, an image region where the image data of an unnecessary subject is present is referred to as an unnecessary subject region, and an image region where the image data of a background subject is present is referred to as a background subject region. Unless otherwise indicated, all images dealt with in the embodiment under discussion are two-dimensional images. The classification information can thus be said to be information for separating the entire image region of each input image into a main subject region and an unnecessary subject region, or information for separating the entire image region of each input image into a main subject region, an unnecessary subject region, and a background subject region. To the photographer, a main subject is a subject of relatively strong interest, whereas an unnecessary subject is a subject of relatively weak interest. A main subject region and an unnecessary subject region can therefore be referred to as a strong-interest region and a weak-interest region respectively. The classification information can also be said to be information for identifying a subject that is of interest to the photographer (that is, a main subject), it can also be referred to as level-of-interest information.

In FIG. 6, a classification information setting section 53 generates the classification information mentioned above, and feeds it to the output image generation section 52. The user can perform an input operation U_{OP1} via the user interface to specify the classification information; when the input operation U_{OP1} is performed, the classification information setting section 53 generates classification information according to the input operation U_{OP1}. According to the classification information, main and unnecessary subjects are determined, and thus the input operation U_{OP1} can be said to be an operation for determining a main subject or an operation for determining an unnecessary subject.

Specifically, for example, through the input operation U_{OP1}, the user can specify a distance range DD via the user interface.

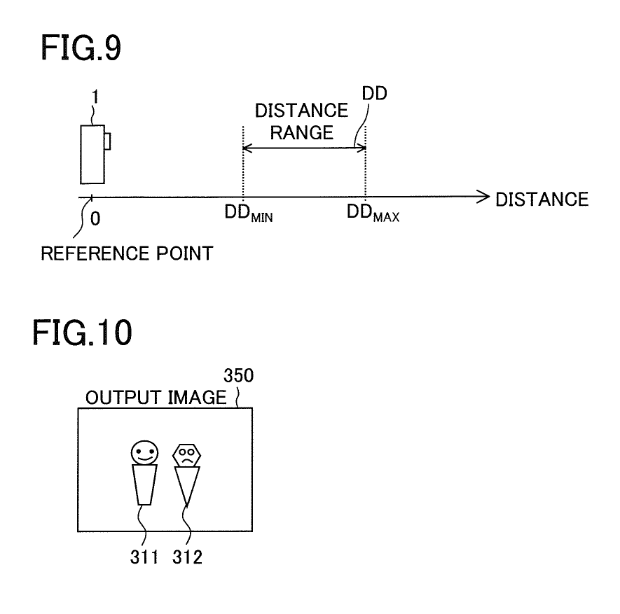

A distance range DD is a range of distance from a reference point in real space. As shown in FIG. 9, the reference point is the position of the image-shooting device 1 at the time of the shooting of input image I[n_{A}], where n_{A} is an arbitrary integer of 1 or more but n or less and its value may be determined beforehand. Then, the distances of the subjects 311 to 313 from the reference point coincide the subject distances d₃₁₁ to d₃₁₃ respectively (see FIG. 4). In the input operation U_{OP1}, the user can enter, directly via the user interface, the minimum distance DD_{MIN} (for example, three meters) and the maximum distance DD_{MAX} (for example, five meters) that define the distance range DD. Instead, for example, with the minimum distance DD_{MIN} and the maximum distance DD_{MAX} taken as the minimum and maximum distances that define the depth of field of the image-sensing section 11, the user may enter, via the user interface, distance derivation data (for example, an aperture value and a focal length) from which the minimum distance DD_{MIN} and the maximum distance DD_{MAX} can be derived. In this case, based on the distance derivation data, the classification information setting section 53 determines the distance range DD.

The user specifies the distance range DD such that a subject (and a background subject as necessary) of interest to him is located inside the distance range DD and a subject that he thinks is unnecessary is located outside the distance range DD. In the embodiment under discussion, where it is assumed that the subjects 311 and 312 are dealt with as main subjects and the subject 313 as an unnecessary subject, the user specifies the distance range DD such that d₃₁₃<DD_{MIN}<d₃₁₁<d₃₁₂<DD_{MAX} holds. The user can instead specify the minimum distance DD_{MIN} alone via the user interface. In that case, the classification information setting section 53 can set the maximum distance DD_{MAX} infinite.

The reference point may be elsewhere than the position of the image-shooting device 1. For example, the center position within the depth of field of the image-sensing section 11 during the shooting of input images I[1] to I[n] may be used as the reference point. Instead, for example, in a case where the input images include a human face, the position at which the face is located (in real space) may be set as the reference point.

When the distance range DD is specified in the input operation U_{OP1}, the classification information setting section 53 can output the distance range DD as classification information to the output image generation section 52; based on the distance range DD, the output image generation section 52 classifies a subject located inside the distance range DD as a main subject and classifies a subject located outside the distance range DD as an unnecessary subject. In a case where the subject group includes a background subject, based on the distance range DD, a subject located inside the distance range DD may be classified as a main subject or a background subject. The output image generation section 52 generates an output image from input images I[1] to I[n] such that a subject located inside the distance range DD appears as a main subject or a background subject on the output image and that a subject located outside the distance range DD is as an unnecessary subject eliminated from the output image.

Basically, for example, by using the distance range DD as classification information and the distance map for input images I[i], the output image generation section 52 separates the entire image region of input images I[i] into a necessary region which is an image region where the image data of a subject inside the distance range DD is present and an unnecessary region which is an image region where the image data of a subject outside the distance range DD is present. This separation is performed on each input image. The necessary region includes a main subject region, and may include a background subject region as well; the unnecessary region includes an unnecessary subject region. As a result of the separation, in each input image, the image region where the image data of the subject 313 is present (in the example shown in FIGS. 8A to 8C, corresponding to the dotted region) is set as an unnecessary region, and the image region where the image data of the subjects 311 and 312 is present is incorporated into a necessary region. Then, for example, out of input images I[1] to I[n], whereas one is set as a reference image (for example, image I_{A}[2] in FIG. 8B), the rest, that is, the input images other than the reference image, are set as non-reference images. Thereafter, the image inside the unnecessary region in the reference image is processed by use of the image data inside the necessary region in the non-reference images so that the unnecessary subject is eliminated from the reference image, and the reference image thus having undergone the elimination is taken as the output image. As a result of the processing using the image data inside the necessary region in the non-reference images, the part (including part of a main subject) shielded by an unnecessary subject in the reference image becomes uncovered in the output image.

The image 350 in FIG. 10 is an example of the output image based on input images I_{A}[1] to I_{A}[3] shown in FIGS. 8A to 8C. To generate the output image 350, it is possible to set, for example, input image I_{A}[2] as a reference image and input images I_{A}[1] and I_{A}[3] as non-reference images. Then, for example, the image inside the unnecessary region in reference image I_{A}[2] (that is, the dotted region within I_{A}[2]) is eliminated from reference image I_{A}[2], and an image inside the unnecessary region in reference image I_{A}[2] is interpolated by using the images inside the necessary regions in non-reference images I_{A}[1] and I_{A}[3] (the images corresponding to the bodies of the subjects 311 and 312). As a result of the interpolation, the output image 350 is obtained, where the part (the image of the bodies of the subjects 311 and 312) shielded by the subject 313 in reference image I_{A}[2] is uncovered.

Next, a description will be given of the composition setting section 54 shown in FIG. 6. The composition setting section 54 generates composition setting information that defines the composition of the output image, and feeds it to the output image generation section 52. The output image generation section 52 performs the output image generation processing such that the output image has the composition defined by the composition setting information.

The user can specify the composition of the output image via the user interface; when the user specifies one, corresponding composition setting information is generated. For example, in a case where, after input images I_{A}[1] to I_{A}[3] shown in FIG. 8B have been, as input images I[1] to I[n], shot and recorded to the recording medium 16, the user wants an output image having a composition like that of input image I_{A}[2] to be generated, the user can specify input image I_{A}[2] as a desired composition image via the user interface. In response to the specification, the composition setting section 54 generates composition setting information such that an output image having a composition like that of the desired composition image (in the example under discussion, input image I_{A}[2]) is generated by the output image generation section 52. As a result, for example, an output image is obtained as if the subjects 311 and 312 were observed in the direction of the optical axis at the time of the shooting of the desired composition image from the position of the image-shooting device 1 at the time of the shooting of the desired composition image, and the positions of the subjects 311 and 312 on the output image coincide with their positions on the desired composition image. In a case where input image I_{A}[2] is the desired composition image, the output image generation section 52 can perform the output image generation processing, for example, with input image I_{A}[2] set as the reference image mentioned above.

As examples of methods of composition setting that can be used in the composition setting section 54, five of them will be described below.

A first method of composition setting is as follows. In the first method of composition setting, before input images I[1] to I[n] are shot by one of the first to third methods of input image generation, or after input images I[1] to I[n] are shot by one of the first to third methods of input image generation, according to a separate operation by the user, the subject group is shot by the image-sensing section 11 to obtain the desired composition image. This ensures that the composition the user desires will be reflected in the output image.

A second method of composition setting is as follows. In the second method of composition setting, after input images I[1] to I[n] are shot by one of the first to third methods of input image generation and recorded, via the user interface, the user specifies one of input images I[1] to I[n] as the desired composition image. This prevents a photo opportunity from being missed on account of obtaining the desired composition image.

A third method of composition setting is as follows. In the third method of composition setting, after input images I[1] to I[n] are shot by one of the first to third methods of input image generation and recorded, without an operation from the user, the composition setting section 54 automatically sets one of input images I[1] to I[n] as the desired composition image. Which input image to set as the desired composition image can be determined beforehand.

A fourth method of composition setting is as follows. The fourth method of composition setting is used in combination with the third method of input image generation that obtains input images from a moving image MI. Consider a case where, as time passes, time points tᵢ, t₂, . . . and, tₘ (where m is an integer of 2 or more) occur in this order and at those time points, a first, a second, . . . and a m-th frame image constituting a moving image MI are shot respectively. The shooting period of the moving image MI is the period between time points t₁ and tₘ. In a case where the fourth method of composition setting is used, at a desired time point during the shooting period of the moving image MI, the user presses a composition specifying button (not shown) provided on the user interface. The frame image shot at the time point when the composition specifying button is pressed is set as the desired composition image. Specifically, for example, in a case where the time point when the composition specifying button is pressed is time point t₂, the second frame image among those constituting the moving image MI is set as the desired composition image. With the fourth method of composition setting, there is no need to shoot the desired composition image separately.

A fifth method of composition setting is as follows. The fifth method of composition setting too is used in combination with the third method of input image generation. In the fifth method of composition setting, the composition setting section 54 takes a time point during the shooting period of the moving image MI as the composition setting time point, and sets the frame image shot at the composition setting time point as the desired composition image. The composition setting time point is, for example, the start time point (that is, time point tᵢ), the end time point (that is, tₘ), or the middle time point of the shooting period of the moving image MI. Which time point to use as the composition setting time point can be determined beforehand. With the fifth method of composition setting, no special operation is needed during the shooting of the moving image MI, nor is there any need to shoot the desired composition image separately.

Next, a description will be given of the depth-of-field setting section 55 shown in FIG. 6. The depth-of-field setting section 55 generates depth setting information that defines the depth of field of the output image, and feeds it to the output image generation section 52. The output image generation section 52 performs the output image generation processing such that the output image has the depth of field defined by the depth setting information.

The user can specify the depth of field of the output image via the user interface; when the user specifies one, corresponding depth setting information is generated. The user can omit specifying the depth of field of the output image, in which case the depth-of-field setting section 55 can use the distance range DD as depth setting information. Or the distance range DD may always be used as depth setting information. In a case where the distance range DD is used as depth setting information, based on the depth setting information, the output image generation section 52 performs the output image generation processing such that the output image has a depth of field commensurate with the distance range DD (ideally, such that the depth of field of the output image coincides with the distance range DD).

The output image generation section 52 may incorporate, as part of the output image generation processing, image processing J for adjusting the depth of field of the output image, so as to be capable of generating the output image according to the depth setting information. The output image having undergone depth-of-field adjustment through the image processing J can be displayed on the display section 15 and in addition recorded on the recording medium 16. One kind of the image processing J is called digital focusing. As methods of image processing for achieving digital focusing, various image processing methods have been proposed. Any of well-known methods that permit the depth of field of the output image to be adjusted on the basis of a distance map (for example, the methods disclosed in JP-A-2010-81002, WO 06/039486, JP-A-2009-224982, JP-A-2010-252293, and JP-A-2010-81050) can be used for the image processing J.

Below, more specific examples of the configuration, operation, and other features, which are based on those described above, of the image-shooting device 1 will be described by way of a few practical examples. Unless inconsistent or otherwise indicated, any of the features described thus far in connection with the image-shooting device 1 is applicable to the practical examples presented below; moreover, two or more of the practical examples may be combined together.

### EXAMPLE 1

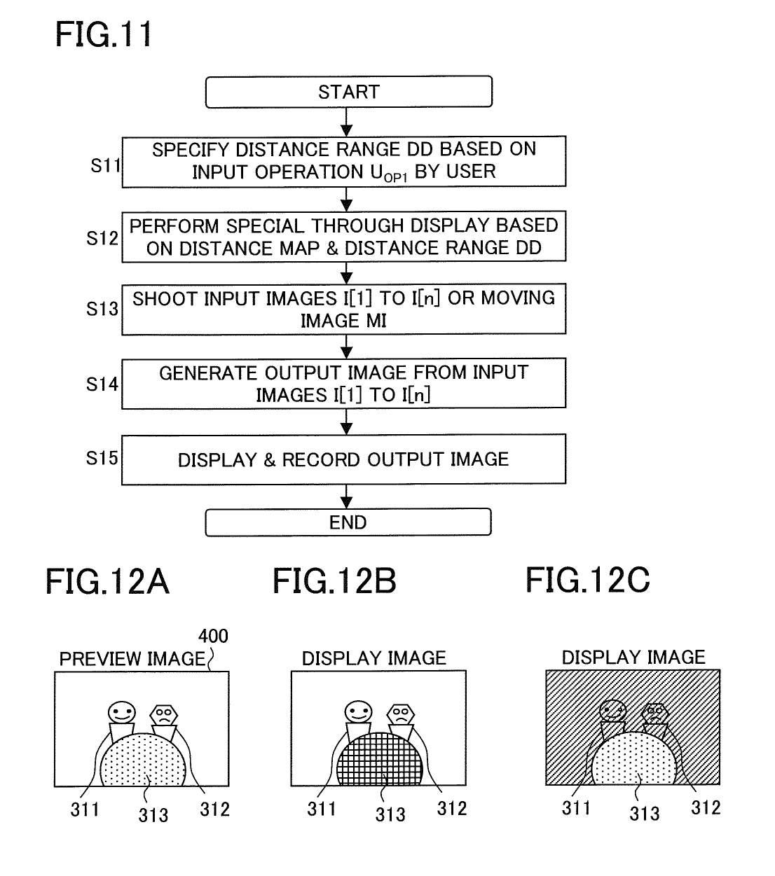

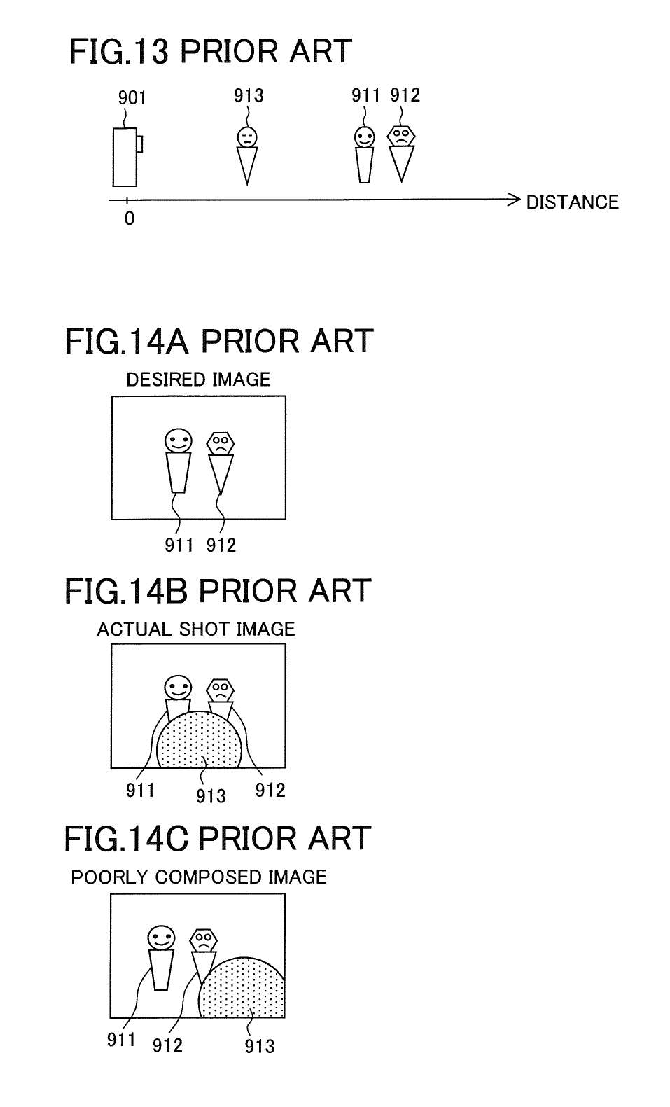

A first practical example (Example 1) will be described. Example 1 deals with the operation sequence of the image-shooting device 1, with focus placed on the operation for generating the output image. FIG. 11 is a flow chart showing the operation sequence. The operations at steps S11 to S15 are performed in this order. Steps S11 to S13 are performed in shooting mode. Steps S14 and S15 may be performed in shooting mode or in playback mode. In Example 1, and also in Examples 2 to 4 described later, any of the first to third methods of input image generation can be used, and any of the first to fifth methods of composition setting can be used.

In shooting mode, before input images I[1] to I[n] are shot, the image-sensing section 11 shoots the subject group periodically; the shot images by the image-sensing section 11 before shooting input images I[1] to I[n] are specially called preview images. The display control section 22 in FIG. 1 displays preview images, which are obtained sequentially, one after another in a constantly updating fashion on the display section 15. This permits the user to confirm the current shooting composition.

At step S11, the user performs the input operation U_{OP1}, and the classification information setting section 53 sets a distance range DD based on the input operation U_{OP1} as the classification information.

After the distance range DD is specified through the input operation U_{OP1}, then at step S12, the display control section 22 makes the display section 15 perform special through display. Special through display denotes display in which, on the display screen on which preview images are displayed one after another, a specific display region and the other display region are presented in such a way that the user can visually distinguish them. The specific display region may be the display region of a main subject, or the display region of an unnecessary subject, or the display region of a main subject and a background subject. Even in a case where the specific display region is the display region of a main subject and a background subject, the user can visually distinguish the display region of an unnecessary subject from the other display region (that is, the display region of a main subject and a background subject). Special through display makes it easy for the user to recognize a specific region (for example, a main subject region or an unnecessary subject region) on the display screen.

For example, when a preview image 400 as shown in FIG. 12A is obtained, based on the distance range DD and the distance map with respect to the preview image 400, the display control section 22 separates the entire image region of the preview image 400 into a specific image region corresponding to the specific display region and the other image region, performs modifying processing on the specific image region of the preview image 400, and displays the preview image 400 having undergone the modifying processing on the display screen. FIGS. 12B and 12C show examples of the preview image 400 having undergone the modifying processing as displayed on the display screen. The modifying processing may be, for example, image processing to increase or reduce the lightness or color saturation of the image inside the specific image region, or image processing to apply hatching or the like to the image inside the specific image region. Or the modifying processing may include any image processing such as geometric conversion, gradation conversion, color correction, or filtering. The display control section 22 can perform the modifying processing on each of preview images that are shot sequentially to display the preview images having undergone the modifying processing in a constantly updating fashion.

The specific image region on which the modifying processing is performed is, when the specific display region is the display region of a main subject, the main subject region and, when the specific display region is the display region of an unnecessary subject, the unnecessary subject region and, when the specific display region is the display region of a main subject and a background subject, the main subject region and the background subject region. The main control section 13 performs subject distance detection processing on the preview image 400 in a manner similar to generating a distance map for an input image, and thereby generates a distance map for the preview image 400.

While special through display is underway at step S12, the user can perform a classification change operation via the user interface to switch a given subject from a main subject to an unnecessary subject. Conversely, the image-shooting device 1 may be so configured that, through a classification change operation via the user interface, a subject can be switched from an unnecessary subject to a main subject.

For example, in a case where the subject group includes, in addition to the subjects 311 to 313 shown in FIG. 4, a subject 311′ (not shown) with the same subject distance as the subject 311, when a distance range DD is specified that fulfills d₃₁₃<DD_{MIN}<d₃₁₁ <d₃₁₂<DD_{MAX}, the image-shooting device 1 sets not only the subjects 311 and 312 but also the subject 311′ as main subjects. At step S12, special through display is performed according to these settings. In this case, if the user considers the subject 311′ as an unnecessary subject, he makes a classification change operation requesting the switching of the subject 311′ to an unnecessary subject. When this classification change operation is made, the image-shooting device 1 re-sets the subject 311′ as an unnecessary subject, and the classification information is corrected so that the output image generation section 52 deals with the subject 311′ as an unnecessary subject. Allowing such correction makes it possible to exclude from the output image the subject 311′ of weaker interest with a subject distance similar to that of the subject 311.

While performing the special through display mentioned above, the image-shooting device 1 waits for entry of a user operation requesting the shooting of input images I[1] to I[n] or a moving image MI; on entry of such a user operation, at step S13, the image-shooting device 1 shoots input images I[1] to I[n] or a moving image MI. The image-shooting device 1 can record the image data of input images I[1] to I[n] or of the moving image MI to the internal memory 14 or to the recording medium 16.

At step S14, based on input images I[1] to I[n] shot at step S13, or based on input images I[1] to I[n] extracted from the moving image MI shot at step S13, the output image generation section 52 generates an output image through the output image generation processing. At step S15, the generated output image is displayed on the display section 15 and in addition recorded to the recording medium 16.

Although the above description deals with a case where the special through display is performed with respect to preview images, it may be performed also with respect to input images I[1] to I[n] or the frame images of a moving image MI.

Although the flow chart described above assumes that the input operation Uₒp₁ is performed in shooting mode, it is also possible to shoot and record input images I[1] to I[n] or a moving image MI in shooting mode first and then perform only the operations at steps S11, S14, and S15 in playback mode.

### EXAMPLE 2

A second practical example (Example 2) will be described. Example 2, and also Example 3, which will be described later, deals with a specific example of the output image generation processing. In Example 2, the output image generation section 52 generates an output image by use of three-dimensional shape restoration processing whereby the three-dimensional shape of each subject included in the subject group is restored (that is, the output image generation processing may include three-dimensional shape restoration processing). Methods of restoring the three-dimensional shape of each subject from a plurality of input images having parallax are well-known, and therefore no description of such methods will be given. The output image generation section 52 can use any well-known method of restoring a three-dimensional shape (for example, the one disclosed in JP-A-2008-220617).

The output image generation section 52 restores the three-dimensional shape of each subject included in the subject group from input images I[1] to I[n], and generates three-dimensional information indicating the three-dimensional shape of each subject. Then, the output image generation section 52 extracts, from the three-dimensional information generated, necessary three-dimensional information indicating the three-dimensional shape of a main subject or the three-dimensional shape of a main subject and a background subject, and generates an output image from the necessary three-dimensional information extracted. Here, the output image generation section 52 generates the output image by converting the necessary three-dimensional information to two-dimensional information in such a way as to obtain an output image having the composition defined by the composition setting information. As a result, for example, an output image (for example, the image 350 in FIG. 10) is obtained as if the subjects 311 and 312 were observed in the direction of the optical axis at the time of the shooting of the desired composition image (for example, I_{A}[2] in FIG. 8B) from the position of the image-shooting device 1 at the time of the shooting of the desired composition image. In a case where the output image generation section 52 is fed with depth setting information, it also adjusts the depth of field of the output image according to the depth setting information.

### EXAMPLE 3

A third practical example (Example 3) will be described. In Example 3, the output image generation section 52 generates an output image by use of free-viewpoint image generation processing (that is, the output image generation processing may include free-viewpoint image generation processing). In free-viewpoint image generation processing, from a plurality of input images obtained by shooting a subject from mutually different viewpoints, an image of the subject as viewed from an arbitrary viewpoint (hereinafter referred to as a free-viewpoint image) can be generated. Methods of generating such a free-viewpoint image are well known, and therefore no detailed description of such methods will be given. The output image generation section 52 can use any well-known method of generating a free-viewpoint image (for example, the one disclosed in JP-A-2004-220312).

By free-viewpoint image generation processing, based on a plurality of input images I[1] to I[n], a free-viewpoint image FF can be generated that shows the subjects 311 and 312 as main subjects as viewed from an arbitrary viewpoint. Here, the output image generation section 52 sets the viewpoint of the free-viewpoint image FF to be generated in such a way as to obtain a free-viewpoint image FF having the composition defined by the composition setting information. Moreover, the free-viewpoint image FF is generated with parts of the input images corresponding to an unnecessary subject masked, and thus no unnecessary subject appears on the free-viewpoint image FF. As a result, for example, as an output image (for example, the image 350 in FIG. 10), a free-viewpoint image FF is obtained as if the subjects 311 and 312 were observed in the direction of the optical axis at the time of the shooting of the desired composition image (for example, I_{A}[2] in FIG. 8B) from the position of the image-shooting device 1 at the time of the shooting of the desired composition image. In a case where the output image generation section 52 is fed with depth setting information, it also adjusts the depth of field of the output image according to the depth setting information.

### EXAMPLE 4

A fourth practical example (Example 4) will be described. Classification information, which can be said to be level-of-interest information, may be generated without reliance on an input operation U_{OP1} by the user. For example, the classification information setting section 53 may generate a saliency map based on the output signal of the image-sensing section 11 and generate classification information based on the saliency map. As a method of generating a saliency map based on the output signal of the image-sensing section 11, any well-known one can be used (for example, the one disclosed in JP-A-2001-236508). For example, from one or more preview images or one or more input images, a saliency map can be generated from which classification information can be derived.

A saliency map is the degree of how a person's visual attention is attracted (hereinafter referred to as saliency) as rendered into a map in image space. A part of an image that attracts more visual attention can be considered to be a part of the image where a main subject is present. Accordingly, based on a saliency map, classification information can be generated such that a subject in an image region with comparatively high saliency is set as a main subject and that a subject in an image region with comparatively low saliency is set as an unnecessary subject. Generating classification information from a saliency map makes it possible, without demanding a special operation of the user, to set a region of strong interest to the user as a main subject region and to set a region of weak interest to the user as an unnecessary subject region.

### Modifications and Variations

The present invention may be carried out with whatever variations or modifications made within the scope of the technical idea presented in the appended claims. The embodiments described specifically above are merely examples of how the invention can be carried out, and the meanings of the terms used to describe the invention and its features are not to be limited to those in which they are used in the above description of the embodiments. All specific values appearing in the above description are merely examples and thus, needless to say, can be changed to any other values. Supplementary comments applicable to the embodiments described above are given in Notes 1 and 2 below. Unless inconsistent, any part of the comments can be combined freely with any other.

Note 1: Of the components of the image-shooting device 1, any of those involved in acquisition of input images, generation and display of an output image, etc. (in particular, the blocks shown in FIG. 6, the display section 15, and the user interface) may be provided in an electronic device (not shown) external to the image-shooting device 1, and the operations described above may be executed on that electronic device. The electronic device may be, for example, a personal computer, a personal digital assistant, or a cellular phone. The image-shooting device 1 also is a kind of electronic device.

Note 2: The image-shooting device 1 and the electronic device may be configured as hardware, or as a combination of hardware and software. In a case where the image-shooting device 1 or the electronic device is configured as software, a block diagram showing those blocks that are realized in software serves as a functional block diagram of those blocks. Any function that is realized in software may be prepared as a program so that, when the program is executed on a program execution device (for example, a computer), that function is performed.

What is claimed is:

1. An electronic device comprising:
an input image acquisition section which acquires a plurality of input images obtained by shooting a subject group from mutually different viewpoints; and
an output image generation section which generates an output image based on the plurality of input images,
wherein the output image generation section eliminates an image of an unnecessary subject within an input image among the plurality of input images by use of another input image among the plurality of input images, and generates, as the output image, an image from which the unnecessary subject has been eliminated.

2. The electronic device according to claim 1, further comprising a user interface which accepts input operation,
wherein the unnecessary subject is determined based on the input operation.

3. The electronic device according to claim 2, wherein
a distance range is specified through the input operation,
the distance range represents a range of distance from a reference point in real space,
the output image generation section generates the output image from the plurality of input images such that a subject located outside the specified distance range is as the unnecessary subject eliminated from the output image.

4. The electronic device according to claim 3, wherein the output image generation section generates the output image such that the output image has a depth of field commensurate with the distance range.

5. The electronic device according to claim 1, wherein
the electronic device is an image-shooting device, and
the image-shooting device as the electronic device further comprises:
an image-sensing section which acquires shot images of the subject group sequentially; and
a display section which displays the shot images sequentially,
the image-shooting device acquiring the plurality of input images by use of the image-sensing section, and
when the shot images are displayed on the display section, a display region of the unnecessary subject and another display region are displayed in a visually distinguishable manner.
